(19) United States
(12) Patent Application Publication
(10) Pub. No.: US 2007/0091128 A1
(43) Pub. Date: Apr. 26, 2007

(54) INK CARTRIDGE FOR PRINTER

(76) Inventors: Junzhong Wu, Zhuhai (CN); Yi Zhou, Zhuhai (CN); Baoquan Chen, Zhuhai (CN)

Correspondence Address: JOHN CHEN, ROOM 303, 3F, NO. 25, SEC. 1, CHANGAN E. ROAD, TAIPEI (R.O.C.), 10441, TW

(21) Appl. No.: 11/565,653

(22) Filed: Dec. 1, 2006

(30) Foreign Application Priority Data
Jun. 9, 2005 (WO) PCT/CN05/00829

(51) Int. Cl. B41J 29/38

(52) U.S. Cl. 347/6

(57) ABSTRACT

An ink cartridge with ink tanks for a printer including a bottom case, a cover, and ink tanks is provided. Inks are classified and stored into independent ink tanks which are assembled in the bottom case. The ink tank includes a negative pressure mechanism for controlling a flow rate of the ink. Soft films are welded on both sides of an ink tank support. During the printing, the inks in the ink tanks a flow through the negative pressure mechanism and get into an inkjet cavity. The ink tank does not have an air intake system, and a volume of the ink tank is changed by changing the shape of the soft films. Thus, the air is isolated from the inks in the ink tanks, and will not get into an ink outlet port.

### BACKGROUND OF THE INVENTION

1. Field of the Invention

The present utility model relates to an ink cartridge with ink tanks for an inkjet printer.

2. Description of Related Art

Currently, methods for controlling an inkjet amount of an ink cartridge with a seal ring at an ink outlet port of an inkjet printer are mainly classified into the following two types.

The first type is one using a sponge to store ink and controlling the printing with the capillary effect of the sponge. After the ink cartridge is used out, too much ink remains in the sponge, which causes a waste of ink, and is not environmentally-friendly, and also increases the cost.

The other type is a spongeless method, which uses a complicated design of an air intake system and a complicated ink cartridge structure, and thus includes too many parts and requires complex processes. Also, due to the height of the negative pressure control value being disposed and the design of the ink path, too much ink will be left.

### SUMMARY OF THE INVENTION

The present invention is directed to provide an ink cartridge with ink tanks for a printer, which comprises a bottom case, a cover, and ink tanks. Inks are classified and stored into independent ink tanks, which is assembled in the bottom case. Each of the ink tanks includes a negative pressure mechanism for controlling a flow rate of the ink. Soft films are welded on both sides of an ink tank support, the inks are stored between the soft films, and a volume between the soft films is variable. During printing, with the consumption of the inks, the volume becomes smaller. The inks flow into an inkjet cavity through a one-way valve. A seal ring, a one-way valve core, and a spring are disposed at an ink outlet port below the inkjet cavity. The ink tank does not have an air intake system, such that the air will not get into the ink tanks, and is isolated from the inks to prevent bubbles entering the ink outlet port. During quick printing, the printing performance is stable and reliable, and the printing quality is improved.

### BRIEF DESCRIPTION OF THE DRAWINGS

FIG. 1 is a stereogram of the internal structure of an ink cartridge according to an embodiment of the present invention.

FIG. 2 is a schematic structural view of the ink tanks according to an embodiment of the present invention.

FIG. 3 is a schematic view of the leakage prevention mechanism of the ink tanks according to an embodiment of the present invention.

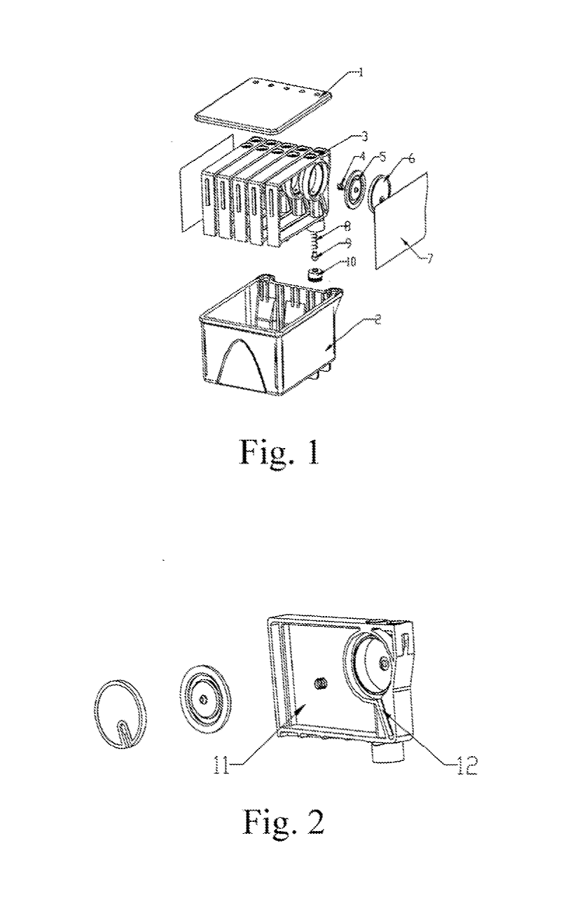

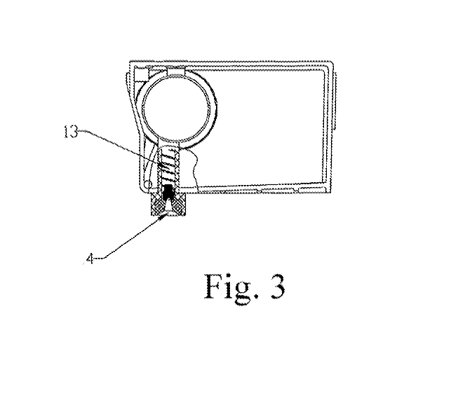

### DESCRIPTION OF EMBODIMENTS

The present invention is further illustrated in detail with an embodiment and the accompanying drawings.

As shown in FIG. 1, the present invention includes a bottom case 2, a cover 1, and an ink tank support 3. Each color of ink is stored in an independent ink tank. The ink tank includes a negative pressure mechanism, which is composed of a valve spring 4, a valve diaphragm 5, and a valve domed cap 6. Soft films 7 are welded on both sides of the ink tank support, and inks are stored in an ink storage cavity 11. The ink storage cavity 11 is formed by the ink tank support 3 and the soft films 7, and has a variable volume. During printing, with the consumption of the inks, the volume of the ink storage cavity becomes smaller. The inks in the ink storage cavity 11 flow into the negative pressure mechanism through an ink path 12, then flow into an inkjet cavity 13, and finally get into an ink outlet port 14.

The ink outlet port of the ink tank includes a leakage prevention mechanism, which is composed of an ink outlet port spring 8, a valve core 9, and a seal ring 10.

What is claimed is:

1. An ink cartridge with ink tanks for a printer, comprising:
a bottom case;
a cover;
at least one ink tank, for storing a certain amount of ink, and assembled in the bottom case;
wherein the ink tank comprises a negative pressure mechanism for controlling a flow rate of ink and preventing the ink leading from a nozzle of a print head;
wherein the ink tank have a support with soft films welded on both sides thereof, and the ink is stored between the soft films.

2. The ink cartridge for a printer as claimed in claim 1, wherein the ink cartridge comprises independent ink tanks for various colors, and the independent ink tanks are replaceable.

3. The ink cartridge for a printer as claimed in claim 1, wherein the ink in the ink tank flows through the negative pressure mechanism and get into an inkjet cavity.

4. The ink cartridge for a printer as claimed in claim 1, wherein a volume between the soft films on both sides of the ink tank support is variable and during printing, with the consumption of the ink between the soft films, the volume between the soft films becomes smaller.

5. The ink cartridge for a printer as claimed in claim 1, wherein the ink tank does not have an air intake system, such that the air is isolated from the inks in the ink tanks and will not get into an ink outlet port.

6. The ink cartridge for a printer as claimed in claim 1, wherein the negative mechanism of the ink tank is a one-way valve mechanism.

7. The ink cartridge for a printer as claimed in claim 1, wherein the soft films of the ink tank are plastic molded or thermal molded.

8. The ink cartridge for a printer as claimed in claim 1, further comprising a leakage prevention mechanism.

9. The ink cartridge for a printer as claimed in claim 8, wherein the leakage prevention mechanism comprises an ink outlet port spring, a valve core, and a seal ring.
